(19) United States
(12) Patent Application Publication
(10) Pub. No.: US 2023/0301405 A1
(43) Pub. Date: Sep. 28, 2023

(54) ROTATABLE WATCH STRAP CONNECTION STRUCTURE

(71) Applicant: Zhiqiang CHEN, Maoming (CN)

(72) Inventor: Zhiqiang CHEN, Maoming (CN)

(21) Appl. No.: 18/325,064

(22) Filed: May 29, 2023

Related U.S. Application Data
(63) Continuation of application No. PCT/CN2021/132358, filed on Nov. 23, 2021.

(51) Int. Cl. A44C 5/14

(52) U.S. Cl. CPC A44C 5/147

(57) ABSTRACT

The present disclosure relates to a rotatable watch strap connection structure, including a connector and a rotating member; a connection unit is arranged between the rotating member and the connector; the connection unit includes a circular shaft, a spring, and a stop collar; the stop collar and the circular shaft are coaxially arranged; the stop collar sleeves the circular shaft; an inner ring of the stop collar is slidably connected with an outer wall of the circular shaft; the spring is arranged in the circular shaft; one end of the spring is connected with an inner wall of the stop collar; the other end of the spring is connected with one end of the circular shaft far from the stop collar; the spring is in a stretched state.

### TECHNICAL FIELD

The present disclosure particularly relates to a rotatable watch strap connection structure.

### BACKGROUND

Most of watch straps in the prior art are fixed, which can only be used on one side and have poor experience. A few of straps that can be used on both sides are also achieved through fixed plug-in structures. Therefore, steps of adjustment are cumbersome, and the practicability is low.

A few of straps that can be used on both sides are also achieved through fixed plug-in structures. Therefore, steps of adjustment are cumbersome, and the practicability is low.

### SUMMARY

The technical problem to be solved in the present disclosure is that: In order to overcome the shortcomings in the prior art, a rotatable watch strap connection structure is provided.

The technical solution used by the present disclosure to solve the technical problem is as follows: A rotatable watch strap connection structure includes a connector and a rotating member. A connection unit is arranged between the rotating member and the connector.

The connection unit includes a circular shaft, a spring, and a stop collar; the stop collar and the circular shaft are coaxially arranged; the stop collar sleeves the circular shaft; an inner ring of the stop collar is slidably connected with an outer wall of the circular shaft; the spring sleeves the circular shaft; one end of the spring is connected with the stop collar; the other end of the spring is connected with one end of the circular shaft far from the stop collar; and the spring is in a stretched state.

A strip-type bulge is arranged on one side of the connector close to the rotating member; a strip-type groove is formed in one side of the rotating member close to the connector; the bulge matches the groove; and the bulge is embedded in the groove.

One end of the circular shaft far from the stop collar is connected with a middle portion of the bulge; the other end of the circular shaft passes through the rotating member; a circular slot matching the stop copper is formed in one side of the rotating member far from the connector; and the stop collar is located in the circular slot.

As a preference, a through hole is formed in the rotating member; the circular shaft passes through the through hole; and an outer diameter of the stop collar is greater than a diameter of the through hole.

Actually, a step structure is arranged to limit the stop collar.

As a preference, a height of the bulge is less than a height of the stop collar.

This is mainly for convenience of double-side adjustment. The height of the boss is restrained to prevent excessive outward pulling of the stop collar.

The present disclosure has beneficial effects: According to the rotatable watch strap connection structure, due to the combination of the elastic action of the connection unit and restriction of the bulge, fixed connection between the connector and the rotating member, and a movable adjustment function are achieved, so that the rotating member can flexibly rotate as required. Therefore, rotation of a strap spring bar and rotation of a strap are achieved, and an effect of wearing the strap on both sides is achieved. The rotatable watch strap connection structure is easy and convenient to operate and high in practicability.

### BRIEF DESCRIPTION OF DRAWINGS

The present disclosure is further described below in detail in combination with the accompanying drawings and embodiments.

FIG. 1 is a schematic structural diagram of a rotatable watch strap connection structure of the present disclosure;

FIG. 2 is a schematic structural diagram of a rotatable watch strap connection structure of the present disclosure;

FIG. 3 is a schematic structural diagram of connection between a connector and a connection unit of a rotatable watch strap connection structure of the present disclosure;

FIG. 4 is a schematic structural diagram of a rotating member of a rotatable watch strap connection structure of the present disclosure; and

FIG. 5 is a schematic structural diagram of a connection unit of a rotatable watch strap connection structure of the present disclosure.

In the drawings: 1: connector; 2: rotating member; 3: stop collar; 4: circular shaft; 5: spring; and 6: bulge.

### DETAILED DESCRIPTION OF THE EMBODIMENTS

The present disclosure is further described in detail below in combination with accompanying drawings. These drawings are simplified schematic diagrams that only illustrate the basic structure of the present disclosure in a schematic manner, so they only display components related to the present disclosure.

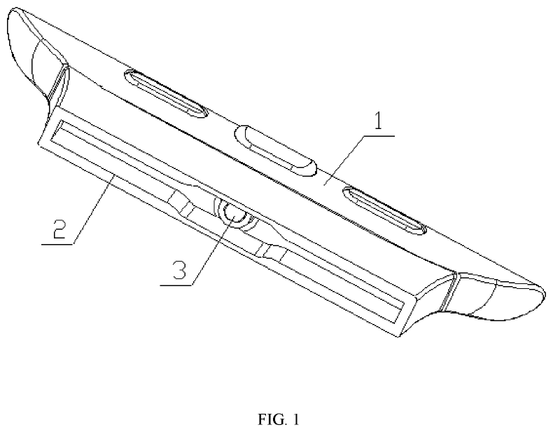

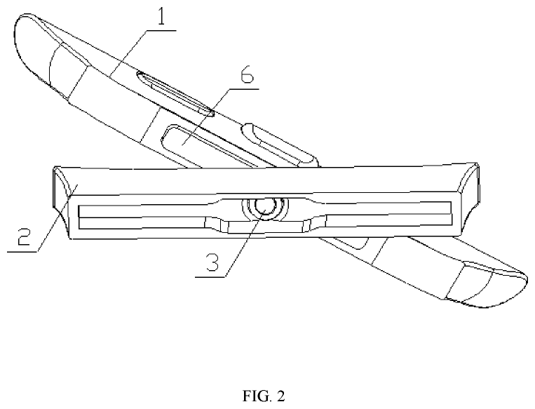

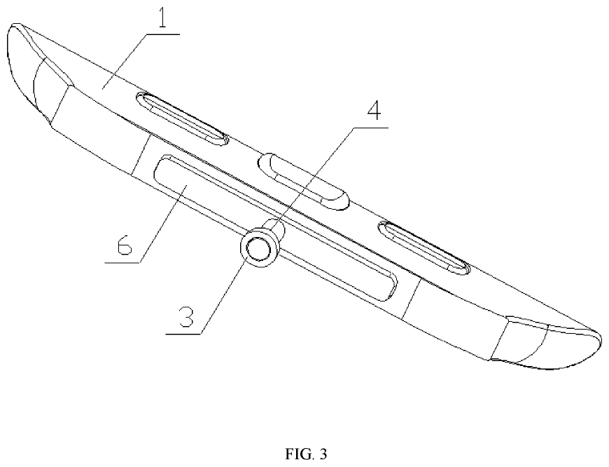

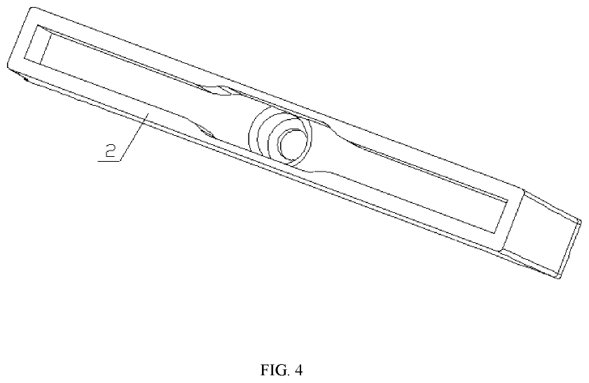

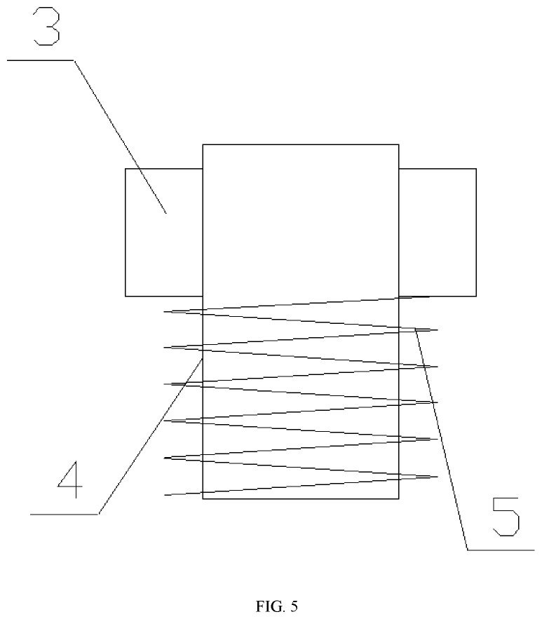

As shown in FIG. 1 to FIG. 5, a rotatable watch strap connection structure includes a connector 1 and a rotating member 2. A connection unit is arranged between the rotating member 2 and the connector 1.

The connection unit includes a circular shaft 4, a spring 5, and a stop collar 3. The stop collar 3 and the circular shaft 4 are coaxially arranged. The stop collar 3 sleeves the circular shaft 4. An inner ring of the stop collar 3 is slidably connected with an outer wall of the circular shaft 4. The spring 5 sleeves the circular shaft 4. One end of the spring 5 is connected with the stop collar 3. The other end of the spring 5 is connected with one end of the circular shaft 4 far from the stop collar 3. The spring 5 is in a stretched state.

A strip-type bulge 6 is arranged on one side of the connector 1 close to the rotating member 2. A strip-type groove is formed in one side of the rotating member 2 close to the connector 1. The bulge 6 matches the groove. The bulge 6 is embedded in the groove.

One end of the circular shaft 4 far from the stop collar 3 is connected with a middle portion of the bulge 6. The other end of the circular shaft 4 passes through the rotating member 2. A circular slot matching the stop copper 3 is formed in one side of the rotating member 2 far from the connector 1. The stop collar 3 is located in the circular slot.

As a preference, a through hole is formed in the rotating member 2. The circular shaft 4 passes through the through hole. An outer diameter of the stop collar 3 is greater than a diameter of the through hole.

Actually, a step structure is arranged to limit the stop collar 3.

As a preference, a height of the bulge 6 is less than a height of the stop collar 3.

This is mainly for convenience of double-side adjustment. The height of the boss 6 is restrained to prevent excessive outward pulling of the stop collar 3.

The connector 1 is connected to a dial of a watch. The rotating member 2 is connected to a strap. If the strap needs to be rotated, the rotating member 2 is just outwards pulled. Synchronously, the rotating member 2 may drive the stop collar 3 to move towards the strap, so that the groove on the rotating member 2 is completely separated from the bulge 6, and the rotating member 2 can rotate around the circular shaft 4 serving as a rotating shaft. After rotation by 180°, the strap is released, that is, the rotating member 2 is released. Under the action of a restoring force of the spring 5, the groove on the rotating member 2 can sleeve the bulge 6. As the bulge 6 and the groove are both strip-type, a stop effect can be achieved to prevent the rotating member 2 from rotating. Furthermore, under the acting force of the spring 5, the rotating member 2 may tightly abut against the connector 1 to fix the rotating member 2 again, thereby achieving rotation of a strap spring bar and then achieving rotation of a strap. An effect of wearing the strap on both sides is achieved.

Compared with the prior art, the rotatable watch strap connection structure has the advantages that due to the combination of the elastic action of the connection unit and restriction of the bulge 6, fixed connection between the connector 1 and the rotating member 2, and a movable adjustment function are achieved, so that the rotating member 2 can flexibly rotate as required. The rotatable watch strap connection structure is easy and convenient to operate and high in practicability.

By taking the above-mentioned ideal embodiments according to the present disclosure as inspiration, through the above-mentioned description, relevant personnel can make various changes and modifications without departing from the scope of the technical idea of the present disclosure. The technical scope of the present disclosure is not limited to the content of the specification, and must be determined according to the scope of the claims.

What is claimed is:

1. A rotatable watch strap connection structure, comprising a connector and a rotating member, wherein a connection unit is arranged between the rotating member and the connector;
the connection unit comprises a circular shaft, a spring, and a stop collar; the stop collar and the circular shaft are coaxially arranged; the stop collar sleeves the circular shaft; an inner ring of the stop collar is slidably connected with an outer wall of the circular shaft; the spring sleeves the circular shaft; one end of the spring is connected with the stop collar; the other end of the spring is connected with one end of the circular shaft far from the stop collar; the spring is in a stretched state;
a strip-type bulge is arranged on one side of the connector close to the rotating member; a strip-type groove is formed in one side of the rotating member close to the connector; the bulge matches the groove; the bulge is embedded in the groove;
one end of the circular shaft far from the stop collar is connected with a middle portion of the bulge; the other end of the circular shaft passes through the rotating member; a circular slot matching the stop copper is formed in one side of the rotating member far from the connector; and
the stop collar is located in the circular slot.

2. The rotatable watch strap connection structure according to claim 1, wherein a through hole is formed in the rotating member; the circular shaft passes through the through hole; and an outer diameter of the stop collar is greater than a diameter of the through hole.

3. The rotatable watch strap connection structure according to claim 1, wherein a height of the bulge is less than a height of the stop collar.
